(19) United States
(12) Patent Application Publication
(10) Pub. No.: US 2026/0131604 A1
(43) Pub. Date: May 14, 2026

(54) Coupling Structure For Vehicle

(71) Applicants: HYUNDAI MOTOR COMPANY, SEOUL (KR); KIA CORPORATION, SEOUL (KR)

(72) Inventor: Su In Park, Hwaseong-si (KR)

(73) Assignees: HYUNDAI MOTOR COMPANY, SEOUL (KR); KIA CORPORATION, SEOUL (KR)

(21) Appl. No.: 19/239,220

(22) Filed: Jun. 16, 2025

(30) Foreign Application Priority Data
Nov. 11, 2024 (KR) 10-2024-0158994

(51) Int. Cl. B60D 1/06; B60D 1/24

(52) U.S. Cl. CPC B60D 1/065; B60D 1/246

(57) ABSTRACT

The present disclosure provides a coupling structure for a vehicle. The vehicle includes a drive module, and a cargo module connected and coupled to the drive module and configured to be moved by power from the drive module. The coupling structure includes an actuator module provided at a rear side of the drive module and connected to a front side of the cargo module, a pair of casting balls connected to the actuator module, provided to face each other, and configured to be operated to move toward or away from each other by the actuator module, and a trailer ball provided at a front side of the cargo module and configured to be fastened to or unfastened from the pair of casting balls.

### CROSS-REFERENCE TO RELATED APPLICATION(S)

This application claims priority to and the benefit of Korean Patent Application No. 10-2024-0158994 filed with the Korean Intellectual Property Office on Nov. 11, 2024, the entire contents of which are incorporated herein by reference.

### TECHNICAL FIELD

The present disclosure relates to a coupling structure for a vehicle, and more particularly, to a coupling structure for a vehicle. The coupling structure includes a drive module having a casting ball to which an electromagnetic force is applied, and a cargo module having a trailer ball configured to be coupled to the casting ball.

### BACKGROUND

In general, a tractor (e.g., drive module) refers to a vehicle that tows a trailer (e.g., cargo module). The tractor is a front vehicle of a large-scale vehicle that mainly pulls cargo or a load (e.g., luggage), and the tractor serves as a drive module. The trailer is a rear vehicle onto which cargo (e.g., luggage) is loaded, and the trailer serves as a cargo module.

A coupler is provided to connect the tractor and the trailer. As illustrated in FIG. 1, a tractor 1 and a trailer 2 are physically fastened by a coupler 3. However, as illustrated in FIGS. 2A, 2B, and 2C, the coupler 3 is configured by coupling a tractor side coupler 3-1 and a trailer side coupler 3-2. When the tractor 1 is rapidly decelerated or rapidly braked in a constant speed state (see FIG. 2A), a front side of the tractor side coupler 3-1 collides with the trailer side coupler 3-2, and an impact is applied (see FIG. 2B). When the tractor 1 is rapidly accelerated in a stationary state or a constant speed state, a rear side of the tractor side coupler 3-1 collides with the trailer side coupler 3-2, and an impact is applied (see FIG. 2C). This is because a clearance is present between the tractor side coupler 3-1 and the trailer side coupler 3-2.

Traveling instability may be caused by the impact or pushing between the tractor 1 and the trailer 2 in the situation in which the tractor 1 accelerates or decelerates or a situation in which the tractor 1 travels on an inclined road. In addition, traveling instability may adversely affect ride quality and may cause the tractor 1 and the trailer 2 to separate. Therefore, there is a desire to develop a coupling structure for a vehicle with the coupling structure being capable of preventing an impact or pushing between the tractor side coupler 3-1 and the trailer side coupler 3-2.

### SUMMARY

The present disclosure provides a coupling structure for a vehicle. The coupling structure is configured to connect a drive module and a cargo module and has a structure including a casting ball to which an electromagnetic force is applied, and a trailer ball configured to be coupled to the casting ball, thereby preventing collisions in forward, rearward, upward, and downward directions when the drive module and the cargo module are fastened, and ensuring ride quality of a passenger seated in the drive module.

An example embodiment of the present disclosure provides a coupling structure for a vehicle, which includes a drive module, and a cargo module connected and coupled to the drive module and configured to be moved by power from the drive module. The coupling structure includes an actuator module provided at a rear side of the drive module and connected to a front side of the cargo module, a pair of casting balls connected to the actuator module, provided to face each other, and configured to be operated to move toward or away from each other by the actuator module, and a trailer ball provided at a front side of the cargo module and configured to be fastened to or unfastened from the pair of casting balls.

The actuator module may have a pair of fastening pins configured to fix (e.g., guide) movements of the casting balls when the trailer ball is fastened to the pair of casting balls.

The fastening pin may protrude from the actuator module and be inserted into a fastening groove formed in the casting ball.

A ball bearing may be provided on an outer peripheral surface of the fastening pin so that the fastening pin rectilinearly reciprocates toward the casting ball in the actuator module.

A cam may be provided at an end of the fastening pin, positioned in the actuator module, and configured to rotate while being in contact with the end of the fastening pin.

The cam may be provided at an end of each of the pair of fastening pins, and the cams and the fastening pins may be synchronized and operated when a gear belt connected to rotary shafts of the pair of cams rotates.

The trailer ball may be connected to the front side of the cargo module by a trailer connection part formed in a shape bent vertically.

An angle restriction groove may be formed in a lower portion of the casting ball so that a part of the bent portion of the trailer connection part may be positioned in the angle restriction groove, and the angle restriction groove may be formed at a predetermined angle to restrict a rotation angle of the trailer ball.

The angle restriction groove may be formed so that the trailer connection part turns within a range of −30° to +30° in an upward/downward direction.

The trailer ball may be configured as a permanent magnet having a first polarity, and a plurality of electromagnets may be formed in the casting ball and have polarities that vary depending on a direction of an electric current.

When the trailer ball is fastened to the casting ball and the vehicle is in a stationary state or travels at a constant speed, the plurality of electromagnets may be formed to have a second polarity opposite to the first polarity.

The electromagnet, which is positioned at a rear side of the vehicle among the plurality of electromagnets, may be changed to have the first polarity when the vehicle accelerates.

The electromagnet, which is positioned at a front side of the vehicle among the plurality of electromagnets, may be changed to have the first polarity when the vehicle decelerates.

The electromagnet, which is positioned at a right side of the vehicle among the plurality of electromagnets, may be changed to have the first polarity when the vehicle turns right.

The electromagnet, which is positioned at a left side of the vehicle among the plurality of electromagnets, may be changed to have the first polarity when the vehicle turns left.

The plurality of electromagnets may be formed to have the first polarity when the trailer ball is separated from the casting ball.

According to the example embodiment of the present disclosure, in the coupling structure for a vehicle including the tractor (drive module) and the trailer (cargo module) coupled to the rear end of the tractor, the two opposite sides of the trailer ball are coupled to the casting balls and fixed by the fastening pins, such that the trailer ball may be stably coupled.

In addition, with the coupling structure including the casting balls, to which the electromagnetic force is applied, and the trailer ball configured as the permanent magnet, the direction may be changed (e.g., softly) while the vehicle turns or travels on the inclined road, thereby improving traveling stability.

In addition, in a rapid acceleration and/or rapid deceleration situation of the vehicle, the electromagnetic force to be applied to the casting ball is (e.g., automatically) controlled, such that the coupling structure may prevent a collision between the two modules, thereby improving ride quality.

Also, in addition to the coupling structure between the tractor and the trailer, the above-mentioned configuration may be applied to a fastening configuration of a PBV (Purpose Built Vehicle) including a drive module and a space module in which a passenger is seated, and a manual method may be changed to an automatic method, thereby improving marketability.

### BRIEF DESCRIPTION OF THE DRAWINGS

FIG. 1 is a view illustrating a coupled state of a vehicle in the prior art in which a tractor and a trailer are fastened by a coupler.

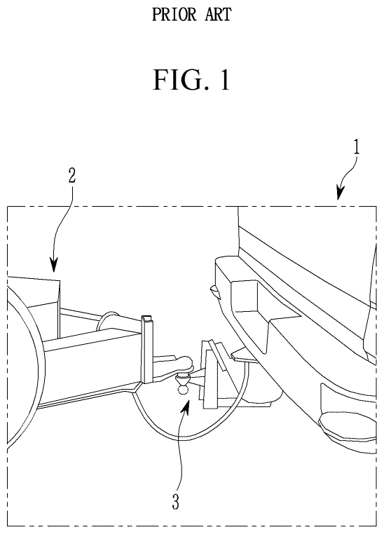

FIGS. 2A, 2B, and 2C are views illustrating a state of the coupler in the prior art in accordance with rapid deceleration and rapid acceleration in a state in which the tractor and the trailer are fastened by the coupler.

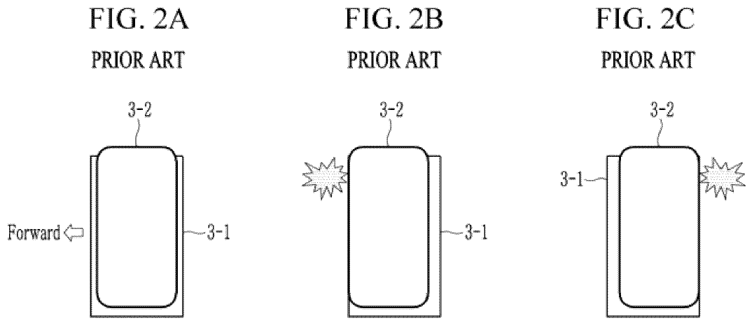

FIG. 3 is a top perspective view illustrating a state before a trailer ball and a casting ball are fastened in a coupling structure for a vehicle according to an example embodiment of the present disclosure.

FIG. 4 is a front view illustrating the state before the trailer ball and the casting ball are fastened in the coupling structure for a vehicle according to the example embodiment of the present disclosure.

FIG. 5 is a front view illustrating a state after the trailer ball and the casting ball are fastened in the coupling structure for a vehicle according to the example embodiment of the present disclosure.

FIG. 6 is a rear view illustrating the state after the trailer ball and the casting ball are fastened in the coupling structure for a vehicle according to the example embodiment of the present disclosure.

FIG. 7 is a bottom perspective view illustrating the state after the trailer ball and the casting ball are fastened in the coupling structure for a vehicle according to the example embodiment of the present disclosure.

FIG. 8 is a view illustrating a state before a fastening pin is coupled to the casting ball in the coupling structure for a vehicle according to the example embodiment of the present disclosure.

FIG. 9 is a view illustrating a state after the fastening pin is coupled to the casting ball in the coupling structure for a vehicle according to the example embodiment of the present disclosure.

FIG. 10 is a view illustrating a rotation angle range in which the trailer ball is turned in the coupling structure for a vehicle according to the example embodiment of the present disclosure.

FIG. 11 is a view illustrating an electronic circuit for changing a polarity of an electromagnet provided on the casting ball in the coupling structure for a vehicle according to the example embodiment of the present disclosure.

FIGS. 12A and 12B are views illustrating a change in polarity of the electromagnet depending on a direction of an electric current in the electronic circuit in FIG. 11.

FIG. 13 is a view illustrating a state in which the trailer ball and the casting ball are coupled in the coupling structure for a vehicle according to the example embodiment of the present disclosure in a state in which a vehicle is stationary or travels at a constant speed.

FIGS. 14A and 14B are views illustrating a state in which the trailer ball and the casting ball are coupled in the coupling structure for a vehicle according to the example embodiment of the present disclosure when the vehicle accelerates and after a predetermined time elapses.

FIGS. 15A and 15B are views illustrating a state in which the trailer ball and the casting ball are coupled in the coupling structure for a vehicle according to the example embodiment of the present disclosure when the vehicle decelerates and after a predetermined time elapses.

FIG. 16 is a view illustrating a state in which the trailer ball and the casting ball are uncoupled in the coupling structure for a vehicle according to the example embodiment of the present disclosure.

FIGS. 17A and 17B are views illustrating a state in which the trailer ball and the casting ball are coupled in the coupling structure for a vehicle according to the example embodiment of the present disclosure when the vehicle turns right and after a predetermined time elapses.

FIGS. 18A and 18B are views illustrating a state in which the trailer ball and the casting ball are coupled in the coupling structure for a vehicle according to the example embodiment of the present disclosure when the vehicle turns left and after a predetermined time elapses.

### DETAILED DESCRIPTION

Hereinafter, embodiments of the present disclosure will be described in detail with reference to the accompanying drawings so that those with ordinary skill in the art to which the present disclosure pertains may carry out the example embodiments. The present disclosure may be implemented in various different ways and is not limited to the example embodiments described herein.

In addition, the constituent elements having the same configurations in several embodiments may be assigned with the same reference numerals and described in the example embodiment. The constituent elements, which are different from the constituent elements according to the example embodiment, may be described in other embodiments.

The drawings are schematic and may not be illustrated based on actual scales. Relative dimensions and proportions of parts illustrated in the drawings may be exaggerated or reduced in size for the purpose of clarity and convenience in the drawings, and any dimension is illustrative but not restrictive. Further, the same reference numerals designate the same structures, elements, or components illustrated in two or more drawings in order to exhibit similar characteristics. When one component is described as being positioned “above” or “on” another component, one component can be positioned “directly on” another component, and one component can also be positioned on another component with other components interposed therebetween.

The embodiment of the present disclosure illustrates an example of the present disclosure. As a result, various modifications of the drawings may be expected. Therefore, the example embodiments are not limited to specific forms in regions illustrated in the drawings, and for example, may include modifications of forms by the manufacture thereof.

Hereinafter, a coupling structure for a vehicle according to an example embodiment of the present disclosure will be described in detail with reference to the accompanying drawings.

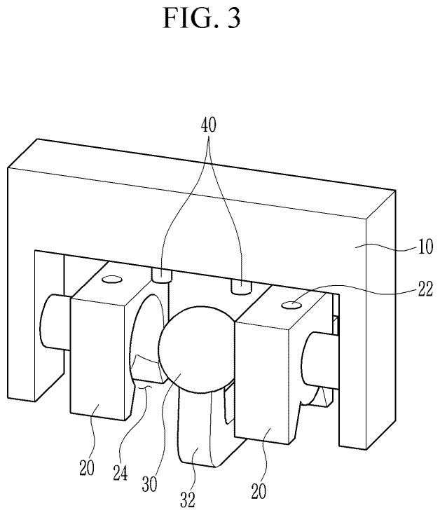

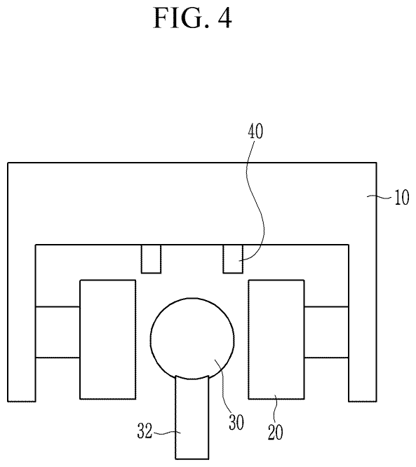

FIG. 3 is a top perspective view illustrating a state of a trailer ball and a casting ball before fastening in a coupling structure for a vehicle according to an example embodiment of the present disclosure, and FIG. 4 is a front view illustrating the state of the trailer ball and the casting ball before fastening in the coupling structure for a vehicle according to the example embodiment of the present disclosure.

With reference to FIGS. 3 and 4, the coupling structure for a vehicle according to the example embodiment of the present disclosure refers to a structure configured by coupling a drive module (not illustrated) and a cargo module (not illustrated) connected to the drive module and configured to be moved by power from the drive module. The coupling structure includes an actuator module (e.g., actuator) 10, casting balls 20, and a trailer ball 30.

In an example embodiment, the drive module may be a tractor configured to provide power, and the cargo module may be a trailer connected to the tractor and configured to accommodate freight, cargo, or the like.

The actuator module 10 may be provided rearward of the drive module, and the casting balls 20 may be provided in the actuator module 10. A combination of the actuator module 10 and the casting balls 20 may be connected to a front side of the cargo module.

The trailer ball 30 may be provided forward of the cargo module and fastened to or unfastened from the casting balls 20.

The actuator module 10 may have a predetermined thickness and a shape that opens downward. The pair of casting balls 20 may be provided to face each other in the opened side and disposed at left and right inner sides of the actuator module 10. The pair of casting balls 20 may be formed symmetrically. The pair of casting balls 20 may be connected to be movable forward or rearward at the left and right inner sides of the actuator module 10, and the pair of casting balls 20 may move toward or away from each other. The portions of the pair of casting balls 20, which face each other, may each be provided in the form of a concave shape having a predetermined diameter so that a spherical body may be inserted into the pair of casting balls 20.

The trailer ball 30 may be formed as a spherical body and positioned between the pair of casting balls 20. The pair of casting balls 20 may move toward each other, and the trailer ball 30 may be coupled to the pair of casting balls 20, such that the drive module and the cargo module may be connected.

Meanwhile, the actuator module 10 may have a pair of fastening pins 40 provided at an upper inner side of the opened side of the actuator module 10 and configured to operate to fix or guide a movement of the casting ball 20. The fastening pin 40 may operate to protrude from or retract into the upper inner side of the actuator module 10. The fastening pins 40 may be fastened to upper portions of the casting balls 20 in a state in which the pair of casting balls 20 are moved toward each other when the trailer ball 30 is fastened to the pair of casting balls 20.

Fastening grooves 22 may be formed in the upper portions of the casting balls 20, and the fastening pins 40 may be inserted and coupled into the fastening grooves 22. The fastening pin 40 may be formed in a cylindrical shape, and the fastening groove 22 may be formed in a shape corresponding to the shape of the fastening pin 40.

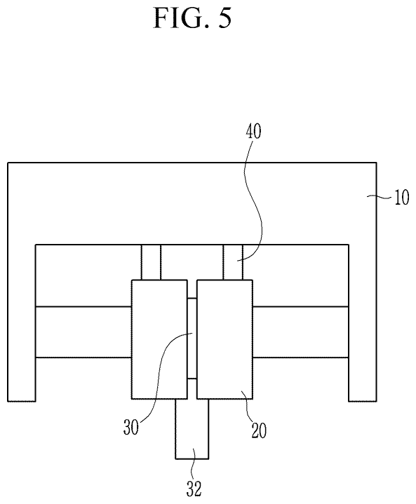

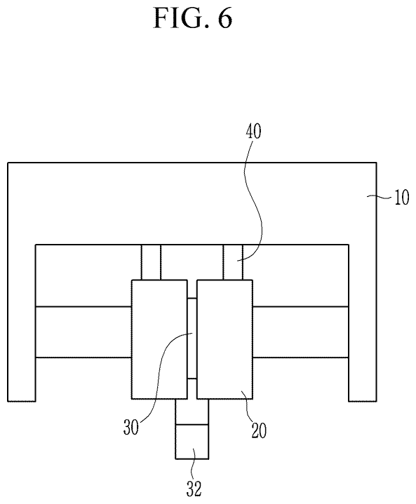

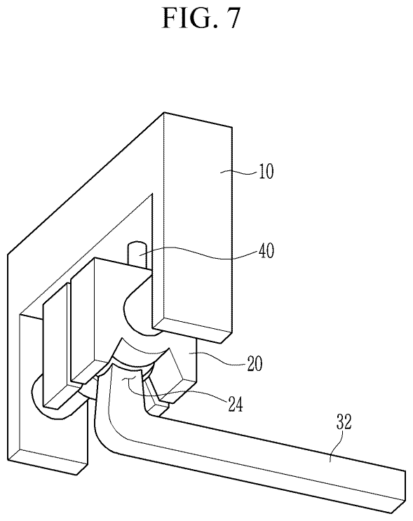

FIG. 5 is a front view illustrating a state after the trailer ball and the casting ball are fastened in the coupling structure for a vehicle according to the example embodiment of the present disclosure, FIG. 6 is a rear view illustrating the state after the trailer ball and the casting ball are fastened in the coupling structure for a vehicle according to the example embodiment of the present disclosure, and FIG. 7 is a bottom perspective view illustrating the state after the trailer ball and the casting ball are fastened in the coupling structure for a vehicle according to the example embodiment of the present disclosure.

With reference to FIGS. 5 to 7, when the drive module and the cargo module are coupled, the casting ball 20 (e.g., is coupled in a shape that) surrounds the trailer ball 30. As shown in the figures, in an example embodiment, the casting ball 20 is a pair of casting balls 20. The trailer ball 30 is positioned between the pair of casting balls 20, and the actuator module 10 moves (e.g., the casting ball 20) forward so that the pair of casting balls 20 move toward each other. The pair of casting balls 20 are coupled in a shape that surrounds the trailer ball 30. In addition, in this state, the fastening pin 40 operates to protrude from the upper inner side of the actuator module 10 and is inserted into the fastening groove 22 formed in the upper portion of the casting ball 20. Therefore, it is possible to prevent the casting ball 20 from moving in the state in which the casting ball 20 is coupled to the trailer ball 30.

Meanwhile, the trailer ball 30 may be connected to a front side of the cargo module by a trailer connection part 32 provided on a lower portion of the trailer ball 30 and formed in a shape bent vertically. The trailer connection part 32 may have a rod shape (e.g., integrally) connected to the lower portion of the trailer ball 30, extending in the vertical direction, and bent in a horizontal direction.

Angle restriction grooves 24 are formed in lower portions of the casting balls 20 so that the trailer connection part 32 may be positioned in the angle restriction grooves 24. The angle restriction grooves 24 may be respectively formed in the lower portions of the pair of casting balls 20 and provide spaces so that the trailer connection part 32 may turn by a predetermined angle in an upward and/or downward direction of the vehicle.

A depth of the angle restriction groove 24 may be smaller than a length of a portion of the trailer connection part 32 extending in the vertical direction. Therefore, when the trailer connection part 32 turns in the upward/downward direction of the vehicle, the trailer connection part 32 comes into contact with the front and rear inner surfaces of the angle restriction groove 24, such that a turning angle may be restricted.

A predetermined clearance may be formed between the casting ball 20 and the trailer ball 30, and, when useful, a lubricant may be applied onto a concave portion of the casting ball 20 so that the trailer ball 30 may rotate in the state in which the trailer ball 30 is fastened to the casting ball 20.

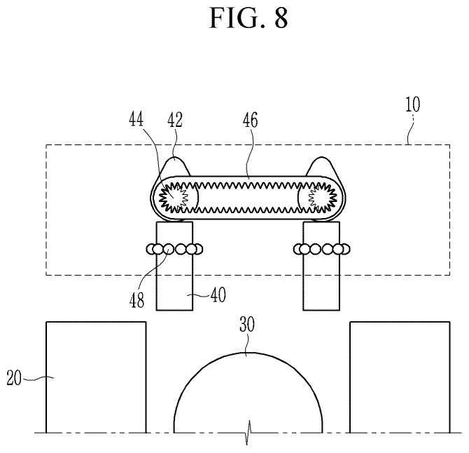

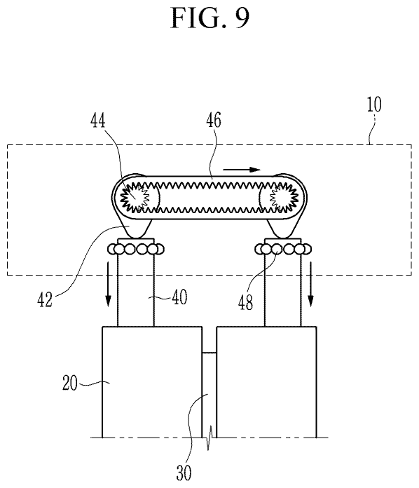

FIG. 8 is a view illustrating a state before the fastening pin is coupled to the casting ball in the coupling structure for a vehicle according to the example embodiment of the present disclosure, and FIG. 9 is a view illustrating a state after the fastening pin is coupled to the casting ball in the coupling structure for a vehicle according to the example embodiment of the present disclosure.

With reference to FIG. 8, the fastening pins 40 are provided in the actuator module 10 and configured to rectilinearly reciprocate toward the casting balls 20, and ball bearings 48 are provided on outer peripheral surfaces of the fastening pins 40. Because the ball bearings 48 are provided, the fastening pin 40 may smoothly reciprocate with a low frictional force in the actuator module 10.

One or more cams 42 (e.g., a pair of cams) may be provided in the actuator module 10 and may be configured to rotate while being in contact with the ends of the fastening pins 40. As shown in the figures, in an example embodiment, a cam of the pair of cams 42 is provided on an end of a fastening pin of the pair of fastening pins 40. In the example embodiment, the pair of cams is respectively provided at the ends of the pair of fastening pins 40. Further, a gear belt 46 is connected to rotary shafts of the pair of cams 42. When the gear belt 46 operates, the pair of cams 42 is synchronized and rotated in the same direction, and the fastening pins 40, which are in contact with the pair of cams 42, are moved forward or rearward together. To this end, when a pair of cams 42 is provided, the (e.g., entire) pair of cams 42 may have an asymmetric shape, such that each cam of the pair of cams 42 has different radii. The fastening pin 40 may move and protrude toward the casting ball 20 when the cam 42 rotates so that a cross-sectional portion of the cam 42, which has a maximum radius from a central axis, comes into contact with the end of the fastening pin 40.

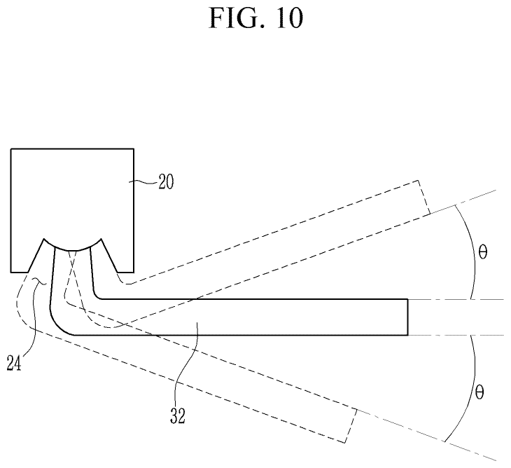

FIG. 10 is a view illustrating a rotation angle range in which the trailer ball is turned in the coupling structure for a vehicle according to the example embodiment of the present disclosure.

With reference to FIG. 10, the trailer connection part 32 formed in the shape bent vertically is provided on the lower portion of the trailer ball 30, and the angle restriction groove 24 is formed in the lower portion of the casting ball 20 so that the trailer connection part 32 is positioned in the angle restriction groove 24. The bent portion of the trailer connection part 32, i.e., the portion of the trailer connection part 32 extending in the vertical direction may come into contact with the front and rear inner surfaces of the angle restriction groove 24, such that a turning angle θ of the trailer connection part 32 may be restricted in the upward/downward direction of the vehicle. In the example embodiment, the angle restriction groove 24 may be formed to allow the trailer connection part 32 to turn within a range of about −30° to about +30° in the upward and/or downward direction of the vehicle.

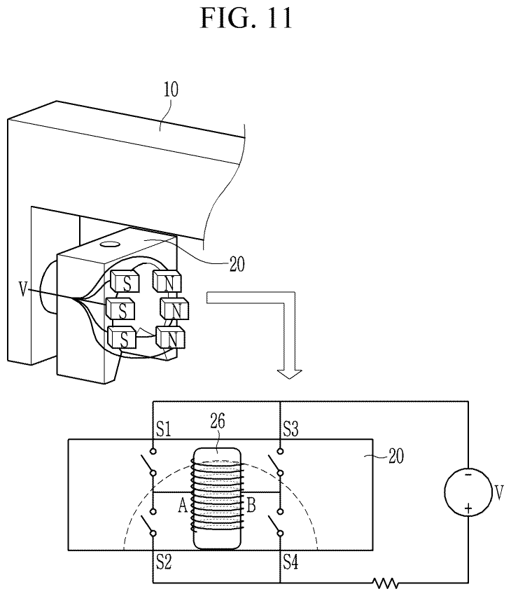

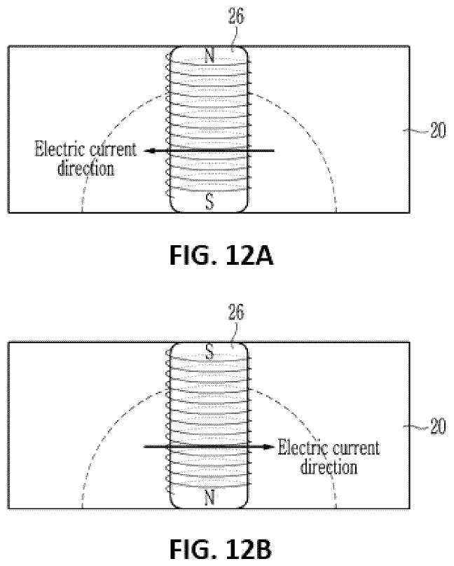

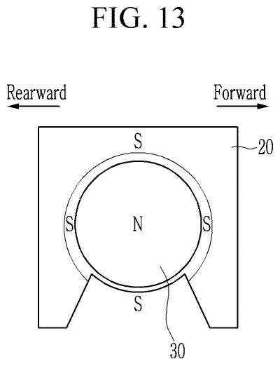

FIG. 11 is a view illustrating an electronic circuit for changing a polarity of an electromagnet provided on the casting ball in the coupling structure for a vehicle according to the example embodiment of the present disclosure, FIGS. 12A and 12B are views illustrating a change in polarity of the electromagnet depending on a direction of an electric current in the electronic circuit in FIG. 11, and FIG. 13 is a view illustrating a state in which the trailer ball and the casting ball are coupled in the coupling structure for a vehicle according to the example embodiment of the present disclosure in a state in which a vehicle is stationary or travels at a constant speed.

In an example embodiment, with reference to FIG. 13, the trailer ball 30 may have a single polarity, and the casting ball 20 may have a changeable polarity and operate to maintain an interval from the trailer ball 30. In the present disclosure, an example embodiment will be described in which the trailer ball 30 has the ‘N’-pole.

As illustrated in FIG. 13, in the state in which the trailer ball 30 and the casting ball 20 are coupled, the trailer ball 30 has the ‘N’-pole, and the (e.g., entire) casting ball 20 has the ‘S’-pole, such that the casting ball 20 may maintain an interval from the trailer ball 30 in a balanced manner.

As illustrated in FIG. 11, a plurality of electromagnets 26 may be provided on an inner portion of the casting ball 20, and the polarities of the plurality of electromagnets 26 may be changed by controlling a switching circuit. Electric wires may be respectively connected and wound around the plurality of electromagnets 26, and the polarities of the electromagnets 26 may be changed depending on the flow direction of the electric current passing through the electric wires.

With reference to FIGS. 11, 12A, and 12B, when the switches S1 and S4 are controlled to be closed, the electric current flows in a direction from B to A in the electromagnet 26. In this case, an upper portion of the electromagnet 26 may have the ‘N’-pole, and a lower portion of the electromagnet 26 may have the ‘S’-pole.

In addition, when switches S2 and S3 are controlled to be closed, the electric current flows in a direction from A to B in the electromagnet 26. In this case, the upper portion of the electromagnet 26 may have the ‘S’-pole, and the lower portion of the electromagnet 26 may have the ‘N’-pole. Depending on the direction of the electric current flowing through the electromagnet 26, the polarity of the portion of the electromagnet 26 may be determined, and the polarity of the inner surface portion of the casting ball 20 may be determined.

The trailer ball 30 may be configured as a permanent magnet having the ‘N’-pole. As illustrated in FIG. 13, the plurality of electromagnets 26 may be formed so that the inner surface portion of the casting ball 20 has the ‘S’-pole when the vehicle is in a stationary state and when the vehicle travels at a constant speed in the state in which the trailer ball 30 is fastened to the casting ball 20.

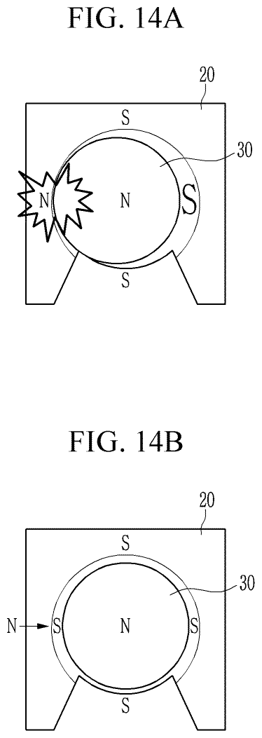

FIGS. 14A and 14B are views illustrating a state in which the trailer ball and the casting ball are coupled in the coupling structure for a vehicle according to the example embodiment of the present disclosure when the vehicle accelerates and after a predetermined time elapses.

With reference to FIGS. 14A and 14B, when the vehicle accelerates, the electromagnet 26, which is positioned at a rear side of the vehicle among the plurality of electromagnets 26, may be changed so that the inner surface portion of the casting ball 20 has the ‘N’-pole. The control is performed so that the same polarity is formed (e.g., on the portion) where there is a risk of impact when the vehicle accelerates, such that a repulsive force is applied. In addition, the control is performed so that the ‘S’-pole is (e.g., strongly) generated on the inner surface portion of the opposite casting ball 20, such that an attractive force is applied (see FIG. 14A). Therefore, the trailer ball 30 may maintain a predetermined interval from the casting ball 20 in all directions.

After a predetermined time elapses after the vehicle accelerates, the electromagnet 26 positioned at the rear side of the vehicle is changed so that the inner surface portion of the casting ball 20 has the ‘S’-pole again, and the ‘S’-pole returns to the original strength at the opposite side (see FIG. 14B).

In a case that the trailer ball 30 has the ‘S’-pole, the polarity of the inner surface portion of the casting ball 20 may be opposite to the polarity described above.

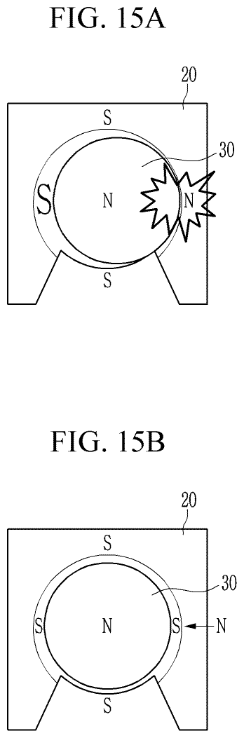

FIGS. 15A and 15B are views illustrating a state in which the trailer ball and the casting ball are coupled in the coupling structure for a vehicle according to the example embodiment of the present disclosure when the vehicle decelerates and after a predetermined time elapses.

With reference to FIGS. 15A and 15B, when the vehicle accelerates, the trailer ball 30 collides with a vehicle front inner side of the casting ball 20 by inertia. Therefore, the control is performed so that the trailer ball 30 has the ‘N’-pole, and the electromagnet 26 has the ‘N’-pole at the vehicle front inner side of the casting ball 20 on the portion where there is a risk of impact during rapid acceleration, such that a repulsive force is applied. In addition, the control is performed so that the ‘S’-pole is (e.g., strongly) generated on the electromagnet 26 inside the casting ball 20 of the opposite casting ball 20, such that an attractive force is applied (see FIG. 15A). Therefore, the trailer ball 30 may maintain a predetermined interval from the casting ball 20 in all directions.

After a predetermined time elapses after the vehicle decelerates, the electromagnet 26 positioned at the front side of the vehicle is changed so that the inner surface portion of the casting ball 20 has the ‘S’-pole again, and the ‘S’-pole returns to the original strength at the opposite side (see FIG. 15B).

Similarly, in a case that the trailer ball 30 has the ‘S’-pole, the polarity of the inner surface portion of the casting ball 20 may be opposite to the polarity described above.

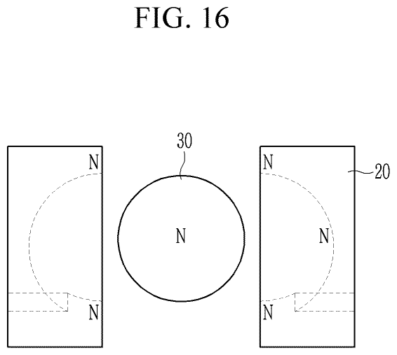

FIG. 16 is a view illustrating a state in which the trailer ball and the casting ball are uncoupled in the coupling structure for a vehicle according to the example embodiment of the present disclosure.

As illustrated in FIG. 16, the control is performed so that in a case that the trailer ball 30 has the ‘N’-pole in the stationary state of the vehicle, the electromagnet 26 inside the (e.g., entire) casting ball 20 has the ‘N’-pole, such that a repulsive force is applied. Further, power is applied to the actuator module 10 so that the casting ball 20 and the trailer ball 30 are uncoupled.

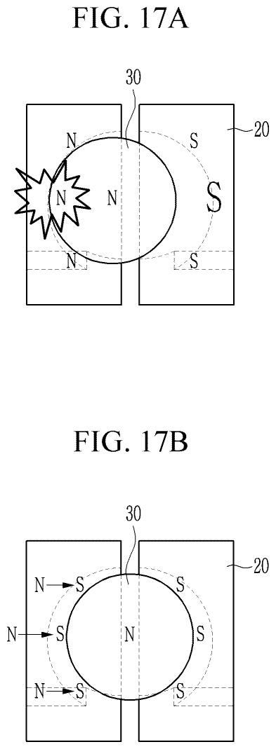

FIGS. 17A and 17B are views illustrating a state in which the trailer ball and the casting ball are coupled in the coupling structure for a vehicle according to the example embodiment of the present disclosure when the vehicle turns right and after a predetermined time elapses.

With reference to FIGS. 17A and 17B, when the vehicle turns right, the trailer ball 30 collides with a right side surface of the casting ball 20 by inertia (FIGS. 17A and 17B illustrate a state when viewed from the front side of the vehicle). Therefore, as illustrated in FIG. 17A, in the example embodiment of the present disclosure, the control is performed so that the trailer ball 30 has the ‘N’-pole, and the electromagnet 26 has the ‘N’-pole at the inner side of the casting ball 20 on the portion where there is a risk of impact when the vehicle turns, such that a repulsive force is applied. In addition, the control is performed so that the ‘S’-pole is (e.g., strongly) generated on the electromagnet 26 inside the casting ball 20 of the opposite casting ball 20, such that an attractive force is applied. Therefore, the trailer ball 30 may maintain a predetermined interval from the casting ball 20 in all directions.

After a predetermined time elapses, the electromagnet 26 positioned at the right side of the vehicle is changed so that the inner surface portion of the casting ball 20 has the ‘S’-pole again, and the ‘S’-pole returns to the original strength at the opposite side (see FIG. 17B).

Likewise, in case that the trailer ball 30 has the ‘S’-pole, the polarity of the inner surface portion of the casting ball 20 may be opposite to the polarity described above.

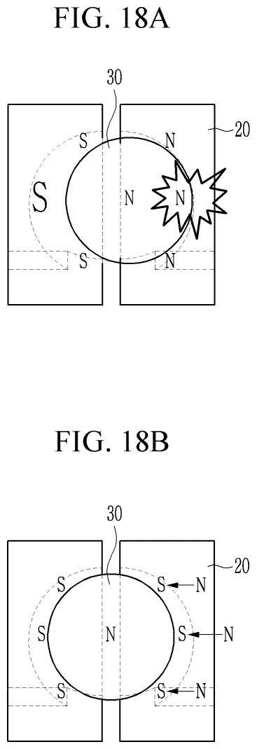

FIGS. 18A and 18B are views illustrating a state in which the trailer ball and the casting ball are coupled in the coupling structure for a vehicle according to the example embodiment of the present disclosure when the vehicle turns left and after a predetermined time elapses.

With reference to FIGS. 18A and 18B, when the vehicle turns left, the trailer ball 30 collides with a left side surface of the casting ball 20 by inertia (FIGS. 18A and 18B illustrate a state when viewed from the front side of the vehicle). Therefore, as illustrated in FIG. 18A, in the example embodiment of the present disclosure, the control is performed so that the trailer ball 30 has the ‘N’-pole, and the electromagnet 26 has the ‘N’-pole at the inner side of the casting ball 20 on the portion where there is a risk of impact when the vehicle turns, such that a repulsive force is applied. In addition, the control is performed so that the ‘S’-pole is (e.g., strongly) generated on the electromagnet 26 inside the casting ball 20 of the opposite casting ball 20, such that an attractive force is applied. Therefore, the trailer ball 30 may maintain a predetermined interval from the casting ball 20 in all directions.

After a predetermined time elapses, the electromagnet 26 positioned at the left side of the vehicle is changed so that the inner surface portion of the casting ball 20 has the ‘S’-pole again, and the ‘S’-pole returns to the original strength at the opposite side (see FIG. 18B).

Similarly, in a case that the trailer ball 30 has the ‘S’-pole, the polarity of the inner surface portion of the casting ball 20 may be opposite to the polarity described above.

As described, according to the example embodiment of the present disclosure, in the coupling structure for a vehicle including the tractor (drive module) and the trailer (cargo module) coupled to the rear end of the tractor, the (e.g., two) opposite sides of the trailer ball are coupled to the casting balls and fixed by the fastening pins, such that the trailer ball may be stably coupled.

In addition, with the coupling structure including the casting balls, to which the electromagnetic force is applied, and the trailer ball configured as the permanent magnet, the direction may be changed (e.g., softly) while the vehicle turns or travels on the inclined road, thereby improving traveling stability.

In addition, when the vehicle rapidly accelerates and/or rapidly decelerates, the electromagnetic force to be applied to the casting ball is (e.g., automatically) controlled, such that the coupling structure may prevent a collision between (e.g., the two) modules, thereby improving ride quality.

Also, in addition to the coupling structure between the tractor and the trailer, the example embodiment may be (e.g., widely) applied to a fastening configuration of a PBV (Purpose Built Vehicle) including a drive module and a space module in which a passenger is seated, and a manual method may be changed to an automatic method, thereby improving marketability.

While the exemplary embodiments of the present disclosure have been described, the present disclosure is not limited to the example embodiment(s). The present disclosure covers (e.g., all) modifications that can be made from the example embodiments of the present disclosure by those skilled in the art and considered as being substantially equivalent to the present disclosure.

What is claimed is:

1. A coupling structure for a vehicle, the vehicle comprises a drive module and a cargo module connected and coupled to the drive module and configured to be moved by power from the drive module, the coupling structure comprising:
an actuator provided at a rear side of the drive module and connected to a front side of the cargo module;
a pair of casting balls connected to the actuator, and the pair of casting balls configured to move toward or away from each other by the actuator; and
a trailer ball provided at a front side of the cargo module and configured to be fastened to or unfastened from the pair of casting balls.

2. The coupling structure of claim 1, wherein:
the actuator has a pair of fastening pins configured to guide movements of the pair of casting balls when the trailer ball is fastened to the pair of casting balls.

3. The coupling structure of claim 2, wherein:
each fastening pin of the pair of fastening pins protrudes from the actuator and configured to be inserted into a fastening groove formed in a casting ball of the pair of casting balls.

4. The coupling structure of claim 3, wherein:
a ball bearing is provided on an outer peripheral surface of each fastening pin of the pair of fastening pins, each fastening pin rectilinearly reciprocates toward the casting ball in the actuator.

5. The coupling structure of claim 4, wherein:
a cam is provided at an end of each fastening pin of the pair of fastening pins, positioned in the actuator, and configured to rotate while being in contact with the end of the fastening pin.

6. The coupling structure of claim 5, the cam is synchronized and operated with the fastening pin when a gear belt connected to a rotary shaft of the cam rotates.

7. The coupling structure of claim 1, wherein:
the trailer ball is connected to the front side of the cargo module by a trailer connection part.

8. The coupling structure of claim 7, wherein the trailer connection part is formed in a shape bent vertically.

9. The coupling structure of claim 8, wherein:
an angle restriction groove is formed in a lower portion of a casting ball of the pair of casting balls so that a part of the trailer connection part is positioned in the angle restriction groove.

10. The coupling structure of claim 9, wherein the angle restriction groove is formed at a predetermined angle to restrict a rotation angle of the trailer ball.

11. The coupling structure of claim 10, wherein:
the angle restriction groove is formed so that the trailer connection part turns within a range of −30° to +30° in an upward/downward direction.

12. The coupling structure of claim 1, wherein:
the trailer ball is configured as a permanent magnet having a first polarity.

13. The coupling structure of claim 12, further comprising a plurality of electromagnets formed in a casting ball of the pair of casting balls, and the plurality of electromagnets have polarities that vary depending on a direction of an electric current.

14. The coupling structure of claim 13, wherein:
when the trailer ball is fastened to the casting ball and the vehicle is in a stationary state or travels at a constant speed, the plurality of electromagnets are formed to have a second polarity opposite to the first polarity.

15. The coupling structure of claim 14, wherein:
an electromagnet of the plurality of electromagnets, positioned at a rear side of the vehicle, is changed to have the first polarity when the vehicle accelerates.

16. The coupling structure of claim 14, wherein:
an electromagnet of the plurality of electromagnets, positioned at a front side of the vehicle, is changed to have the first polarity when the vehicle decelerates.

17. The coupling structure of claim 14, wherein:
an electromagnet of the plurality of electromagnets, which is positioned at a right side of the vehicle, is changed to have the first polarity when the vehicle turns right.

18. The coupling structure of claim 14, wherein:
an electromagnet of the plurality of electromagnets, which is positioned at a left side of the vehicle, is changed to have the first polarity when the vehicle turns left.

19. The coupling structure of claim 13, wherein:
the plurality of electromagnets are formed to have the first polarity when the trailer ball is separated from the casting ball.

20. The coupling structure of claim 1, wherein the pair of casting balls provided to face each other.
